(19) United States
(12) Patent Application Publication
(10) Pub. No.: US 2023/0351581 A1
(43) Pub. Date: Nov. 2, 2023

(54) SYSTEM, DEVICE, AND PROCESS FOR MONITORING EARTH WORKING WEAR PARTS

(71) Applicant: ESCO GROUP LLC, PORTLAND, OR (US)

(72) Inventors: Christopher Alan Jenson, Portland, OR (US); Ankit Saxena, Jammu and Kashmir (IN); Rayadurai Muthusamy, Kallakurichi, Tamil Nadu (IN)

(73) Assignee: ESCO Group LLLC, Portland, OR (US)

(21) Appl. No.: 18/016,863

(22) PCT Filed: Jul. 23, 2021
(86) PCT No.: PCT/IB2021/000491

§ 371 Date: Jan. 18, 2023

Related U.S. Application Data
(60) Provisional application No. 63/055,138, filed on Jul. 22, 2020.

(51) Int. Cl. G01C 11/00; E02F 9/26; G06T 7/00

(52) U.S. Cl. CPC G06T 7/001; E02F 9/26; G01C 11/00; G06T 2207/20084; G06T 2207/30164

(57) ABSTRACT

The disclosed systems and methods define applications in any environment in which a user wishes to determine the wear of a wear part. By using a process to capture a digital representation of the wear part and determining certain dimensions of the part from the digital representation, the disclosed systems and/or methods allow a user to easily assess the part for wear without having detailed knowledge about the part or its wear characteristics.

### RELATED APPLICATIONS

This application is based upon International Application No. PCT/IB2021/000491, filed Jul. 23, 2021, entitled “which claims priority benefits to U.S. Provisional Pat. Application No. 63/055,138 filed Jul. 22, 2020, entitled “SYSTEM, DEVICE, AND PROCESS FOR MONITORING EARTH WORKING WEAR PARTS” Each of these applications are incorporated by reference herein in its entirety and made a part hereof.”

### FIELD OF THE INVENTION

The present disclosure relates to systems, processes and devices for monitoring ground engaging products secured to earth working equipment to assist earth working operations by, for example, determining a dimension, e.g. length of a wear part, wear of the wear part, estimating fully worn end of life conditions, scheduling replacement of ground engaging parts, sending reports and alerts, and/or the like.

### BACKGROUND OF THE INVENTION

In mining and construction, ground engaging products (e.g., teeth, picks, adapters, intermediate adapters, shrouds, wings, etc.) are commonly provided on earth working equipment (e.g., buckets, drums, truck trays, etc.) to protect the underlying equipment from undue wear and, in some cases, also perform other functions such as breaking up the ground ahead of the digging edge. For example, buckets for excavating machines (e.g., dragline machines, cable shovels, face shovels, hydraulic excavators, wheel loaders and the like) are typically provided with teeth secured along a lip of the bucket. A tooth includes a point secured to an adapter or base secured to the lip or formed as a projection on the lip. The point initiates contact with the ground and breaks up the ground ahead of the digging edge of the bucket.

During use, ground engaging products can encounter heavy loading and highly abrasive conditions. These conditions cause the products to wear and eventually become fully worn, e.g., where they need to be replaced. Products that are not timely replaced can be lost, cause a decrease in production, create unsafe working conditions, and/or lead to unnecessary wear of other components (e.g., the base) and damage upstream equipment, e.g. crushers.

Currently, a supplier will have an inspector assigned to a mining site that will inspect supplied wear components of an earth working machine and give a safety report on the wear of those wear components daily. The difficulty lies in the time it takes an inspector to get permission to enter a mine site, coordinate with the maintenance team of the site to be escorted, await the downtime of the earth working machine, and install and remove hazard demarcations so an inspection may be conducted.

### SUMMARY OF THE INVENTION

The present invention pertains to a system and/or process for inspecting wear of wear members on earth working equipment by determining a dimension of the wear member. Certain examples of the disclosure involve a streamlined and/or easier process for capturing data on the parts and determining the dimension and wear of a ground engaging product secured to earth working equipment. Disclosed herein are apparatuses, methods, and computer-readable media for monitoring and/or predicting wear life of ground engaging products to lessen unplanned downtime and/or improve supply chain accuracy.

The disclosed systems and methods define applications in any environment in which a user wishes to determine the wear of a wear part. By using an application (“app”) to capture a digital representation (e.g. image) of the wear part and determining certain dimensions of the part from the digital representation, the disclosed systems, devices, and/or methods allow the user to easily assess the part for wear without having detailed knowledge about the part or its wear characteristics. In this way, operators of the earth working machines can become inspectors, as well as, automated or non-automated devices can become inspectors.

One aspect of the disclosure relates to a method for determining a dimension of a wear part using a digital representation. In one example, the method may include capturing, using the mobile device, at least one digital representation of a wear part of a machine. In another implementation, the method may include using a computing system having an imaging device. The method may include using a computing system having an augmented reality display. The method may further include determining, based on at least one digital representation, an amount of wear of the wear part. In one implementation, the augmented reality display could include blocking out all the surrounding area and displaying only an outline of the wear part to direct the capture orientation and alignment.

In one example, the mobile device may include an imaging device, an input device for receiving input from a user of the mobile device, a storage device storing an application, and a processor. The processor may be configured to execute the stored application to receive, via the input device, a command from the user to capture an image, and capture, using the imaging device and responsive to the command, at least one digital representation of a wear part of a machine. The processor may be further configured to determine, based on at least one digital representation and a template, a dimension of the wear part. The dimension of the wear part being determined will allow the processor to determine the amount of wear in a given time period. This determination along with a work bench digital representation can be used by the processor to determine an expected end of life for the wear part. In another implementation, the processor that determines wear may be separate from the mobile device.

In another example, a process determines a dimension of the ground engaging product, and operates at least one processor and memory storing computer-executable instructions to calculate from a template the extent of wearing experienced by the ground engaging product and/or from the wearing and work bench image an estimate of when the ground engaging product will reach a fully worn condition.

Still another aspect of the disclosure relates to a method for determining wear using a mobile device. In one example, the method may include receiving, over an electronic communication network from the mobile device, at least one digital representation of a wear part of a machine. The method may include an alert indication if a hazardous situated is observed. In another implementation, if the wear has reached beyond a predetermined threshold, an alert can be issued. In at least one aspect, the alerts issue as e-mail. The method may further include determining, based on the at least one digital representation, a template, a dimension, e.g. length of the wear part, and sending, over the electronic communication network to the mobile device, an indication of the determined amount or degree of wear of the wear part.

In a further example, a process of monitoring a ground engaging product secured to earth working equipment includes capturing, via a mobile device, an image comprising the ground engaging product secured to the earth working equipment, and displaying, via a user interface on the mobile device, the captured image of the ground engaging product, and a template overlying the captured image of the ground engaging product to indicate a dimension of the ground engaging product. In one implementation the overlaid template includes at least two reference points, which are used to determine a dimension of the wear part.

In yet another example, a computing device for monitoring a ground engaging product secured to earth working equipment includes at least one processor, a user interface, an imaging device (e.g., a camera, augmented reality headset, etc.), and memory storing computer-executable instructions that, when executed by the processor(s), causes the mobile device to capture an image of the ground engaging product secured to the earth working equipment and an image of a work bench, determine a dimension of the ground engaging product in the image from an overlaid template, and calculate an extent of wear present in the ground engaging product and/or an estimate of the remaining useful life using at least the dimension determined.

In one example, an application stored on a mobile device may be used to capture digital representations related to ground engaging product products at a site. An image processing server may receive the digital representations of at least one a work bench and a ground engaging product and determine a dimension for the ground engaging product. The dimension may be compared with a previously measured dimension to obtain an amount of wear over a given time frame.

In an example, a method for determining a dimension of a wear part using a digital representation includes capturing at least one digital representation of a wear part of an earth working machine in a predetermined orientation and a predetermined alignment; receiving, the digital representation of the wear part; identifying the wear part in the image; bounding the identified wear part within a box and defining an aspect ratio of the identified wear part; and determining a dimension of the identified wear part by relating the aspect ratio of the identified wear part within the box with an aspect ratio associated a wear part having a known dimension.

In another example, a mobile device includes an imaging device, an input device for receiving input from a user of the mobile device, a storage device storing an application, and a processor configured to execute the stored application to: receive, via the input device, a command from the user to capture an image, capture, using the imaging device and responsive to the command, at least one digital representation of a wear part of an earth working machine; receive, the digital representation of the wear part; identify the wear part in the image; bound the identified wear part within a box and defining an aspect ratio of the identified wear part; and determine a dimension of the identified wear part by relating the aspect ratio of the identified wear part with on an aspect ratio of a second wear part having a known dimension.

In a further example, a system for determining a dimension of a wear part using a digital representation includes an imaging device for taking at least one digital representation; a storage device storing an application, and a processor configured to execute the stored application to: capture, using the imaging device and responsive to the command, at least one digital representation of a wear part of a machine; receive, the digital representation of the wear part; identify the wear part in the image; bound the identified wear part within a box and defining an aspect ratio of the identified wear part; and determine a dimension of the identified wear part by relating the aspect ratio of the identified wear part with on an aspect ratio being associated with a second wear part having a known dimension.

In one aspect of the disclosure, a method for determining a dimension of a wear part using a digital representation includes capturing at least one digital representation of a wear part of an earth working machine; receiving, the digital representation of the wear part; identifying the wear part in the image; bounding the identified wear part within an outline of the wear part; and determining a dimension of the identified wear part by relating the bounded wear part with on a wear profile associated with a second wear part having a known dimension.

In another example, a mobile device includes an imaging device, an input device for receiving input from a user of the mobile device, a storage device storing an application, and a processor configured to execute the stored application to: receive, via the input device, a command from the user to capture an image, capture, using the imaging device and responsive to the command, at least one digital representation of a wear part of an earth working machine; receive, the digital representation of the wear part; identify the wear part in the image; bound the identified wear part within an outline of the wear part; and determine a dimension of the identified wear part by relating the bounded wear part with on a wear profile being associated with a second wear part having a known dimension.

In a further example, a system for determining a dimension of a wear part using a digital representation includes an imaging device for taking at least one digital representation; a storage device storing an application, and a processor configured to execute the stored application to: capture, using the imaging device and responsive to the command, at least one digital representation of a wear part of a machine; receive, the digital representation of the wear part; identify the wear part in the image; bound the identified wear part within an outline of the wear part; and determine a dimension of the identified wear part by relating the bounded wear part with on a wear profile being associated with a second wear part having a known dimension.

In yet another example, a method for determining a dimension of a wear part using a digital representation includes capturing a plurality of digital representations of at least two wear parts of an earth working machine; receiving, the stream of the plurality of digital representations of the at least two wear parts; modeling the at least two wear parts as a 3-dimensional (3D) object using the digital representations; identifying at least two wear parts; assigning a first pixel value associated with a desired dimension on one of the at least two wear parts and a second pixel value for a known dimension; and determining the desired dimension of the at least one wear part by relating the first pixel value with the second value.

In one example, a mobile device includes an imaging device, an input device for receiving input from a user of the mobile device, a storage device storing an application, and a processor configured to execute the stored application to: receive, via the input device, a command from the user to capture a plurality of digital representations, capture the plurality of digital representations of at least two wear parts of an earth working machine; receive, the stream of the plurality of digital representations of the at least two wear parts; model the at least two wear parts as a 3-dimensional object using the plurality of digital representations; identify at least two wear parts; assign a first pixel value associated with a desired dimension on one of the at least two wear parts and a second pixel value for a known dimension; and determine the desired dimension of the at least one wear part by relating the first pixel value with the second value.

In another example, a system for determining a dimension of a wear part using a digital representation includes an imaging device for taking at least one digital representation; a storage device storing an application, and a processor configured to execute the stored application to: capture the plurality of digital representations of at least two wear parts of an earth working machine; receive, the stream of the plurality of digital representations of the at least two wear parts; model the at least two wear parts as a 3-dimensional object using the plurality of digital representations; identify at least two wear parts; assign a first pixel value associated with a desired dimension on one of the at least two wear parts and a second pixel value for a known dimension; and determine the desired dimension of the at least one wear part by relating the first pixel value with the second value.

In a further example, a method for determining a dimension of a wear part using a digital representation includes capturing a digital representation of at least two wear parts of an earth working machine; receiving, the digital representation of the at least two wear parts; identifying at least two wear parts; assigning a first pixel value associated with a desired dimension on one of the at least two wear parts and a second pixel value for a known dimension; and determining the desired dimension of the at least one wear part by relating the first pixel value with the second value.

In yet another example, a mobile device includes an imaging device, an input device for receiving input from a user of the mobile device, a storage device storing an application, and a processor configured to execute the stored application to: receive, via the input device, a command from the user to capture a plurality of digital representations, capture a digital representation of at least two wear parts of an earth working machine; receive, the digital representation of the at least two wear parts; identify at least two wear parts; assign a first pixel value associated with a desired dimension on one of the at least two wear parts and a second pixel value for a known dimension; and determine the desired dimension of the at least one wear part by relating the first pixel value with the second value.

In one example, a system for determining a dimension of a wear part using a digital representation includes an imaging device for taking at least one digital representation; a storage device storing an application, and
a processor configured to execute the stored application to: capture a digital representation of at least two wear parts of an earth working machine; receive, the digital representation of the at least two wear parts;
identify at least two wear parts; assign a first pixel value associated with a desired dimension on one of the at least two wear parts and a second pixel value for a known dimension; and determine the desired dimension of the at least one wear part by relating the first pixel value with the second value.

Further examples of the disclosure may be provided in a computer-readable medium having computer-executable instructions that, when executed, cause a computing device, user terminal, or other apparatus to at least perform one or more of the processes described herein.

### BRIEF DESCRIPTION OF THE DRAWINGS

FIG. 1 shows an illustrative exemplary operating environment in which various aspects of the disclosure may be implemented.

FIG. 2 is a representation of an exemplary processing system of one example consistent with the disclosure.

FIG. 3 is a flow diagram illustrating the steps associated with capturing an image of the wear part and creating an alert.

FIG. 4 is a representation of an exemplary graphical user interface (GUI) display of a mobile device.

FIG. 5A shows a user using an imaging device to take an image of a wear part.

FIG. 5B shows a tool using an imaging device to take an image of a wear part.

FIG. 5C shows a vehicle using an imaging device to take an image of a wear part.

FIG. 5D shows a robot using an imaging device to an image of a wear part.

FIGS. 6-10 show exemplary screen shots of a mobile device during the process of setup and image capture of a ground engaging product in accordance with certain aspects of the present disclosure.

FIG. 11A is an exemplary wear part image with a template having two reference points for measuring wear.

FIG. 11B is a second exemplary wear part image with a second template having two reference points for measuring wear.

FIG. 12 is a flow diagram illustrating the steps associated with image processing a captured image and creating an alert.

FIG. 13 is a flow diagram illustrating the steps associated with image processing a captured image and creating an alert.

FIG. 14 is an exemplary image with an aspect ratio boundary box surrounding a point.

FIG. 15 is a second flow diagram illustrating the steps associated with image processing a captured image and creating an alert.

FIG. 16 is an exemplary image of “filled in” geometric outline of a wear part.

FIG. 17 is a third flow diagram illustrating the steps associated with image processing a captured image and creating an alert.

FIG. 18 is an exemplary 3D model created by the images in the path shown.

FIG. 19 is a fourth flow diagram illustrating the steps associated with image processing a captured image and creating an alert.

FIG. 20 is an exemplary image with wear parts identified and known parameters shown.

### DETAILED DESCRIPTION OF THE PREFERRED EXAMPLES

In accordance with various examples of the disclosure, apparatus, methods, and computer-readable media are disclosed to document use, predict and/or monitor wear life of ground engaging products to lessen unplanned downtime and/or improve supply chain accuracy. In certain examples, a mobile device may capture an image of a ground engaging product, measure a dimension, determine wear, calculate the remaining life of the product, and/or convey information associated with the remaining life of the product to a client-side system and/or a ground engaging product provider or other third party, and generate and/or send one or more alert notifications to the client and/or third party of approaching end-of-life target conditions of a ground engaging product and/or hazardous conditions of the ground engaging product.

The processes disclosed herein may utilize various hardware components (e.g., processors, communication servers, non-transient memory devices, sensors, etc.) and related computer algorithms to predict and/or monitor wear life and/or usage of ground engaging product products.

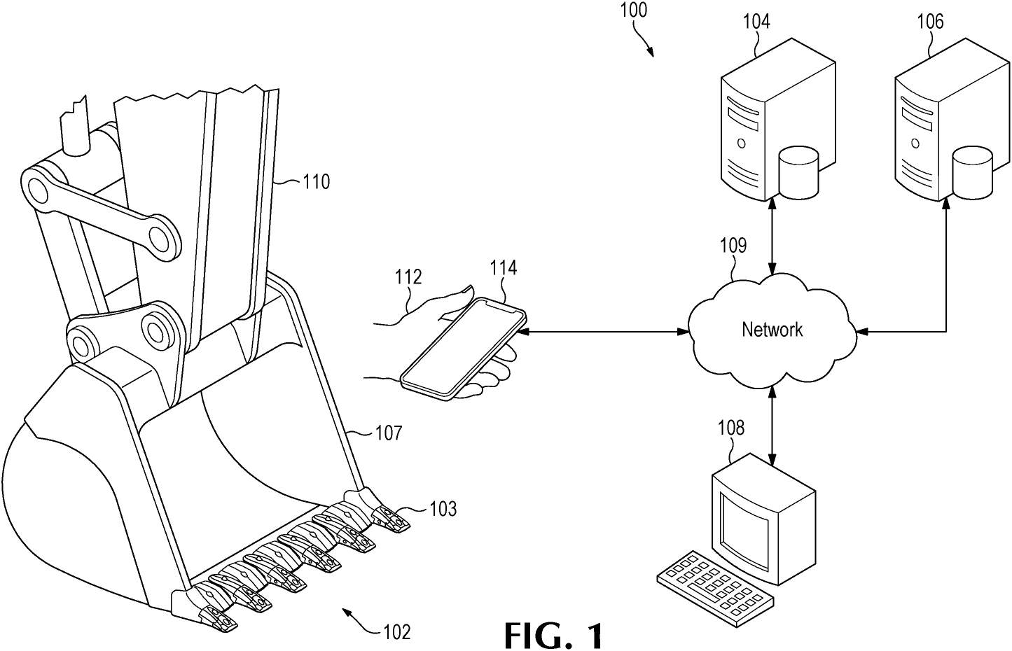

FIG. 1 illustrates an exemplary environment 100 for determining a dimension and wear of a wear component 103 on an earth working equipment (in this example a bucket) secured to an earth working machine 110 by capturing an image of the wear component 103. The environment 100 may include a user 112, a network 109, a computing system 114, an image processing system 104, an alert notification system 106, and a client-side computing system 108. Although shown in this example as separate components, various components could be combined such as the image processing system 104, the alert notification system 106 and/or the client-side computing system 108. Other configurations of the environment are envisioned. The environment 100 may include more or less components than illustrated. Another implementation of the environment may include a supplier system that may have desire to know when a replacement part is used in order to provide future service to the client. For example, an application store may also be a component of the environment. The application store may store and provide a wear usage application to execute on the computing system 114.

Aspects of the disclosure may be implemented using special purpose computing systems 114, environments, and/or configurations. In some instances, the computing systems, environments, and/or configurations that may be used in implementing one or more aspects of the disclosure may include one or more additional and/or alternative personal computers, server computers, hand-held devices, laptop devices, augmenting reality headsets, multiprocessor systems, microprocessor-based systems, set top boxes, programmable consumer electronics, network PCs, minicomputers, mainframe computers, and distributed computing environments to perform certain aspects of the disclosure.

In one implementation, the computing device 114 may be, for example, a computer, a mobile phone, a tablet, personal digital assistant (PDA), a network-enabled digital camera, or other such portable computing devices that can be held and/or carried by an operator 112. The computing device could alternatively be mounted on a stationary or adjustable support. Devices 114 preferably include a built-in imaging device (e.g., camera and/or camera attachments) for capturing image data associated with one or more ground engaging products, but the imaging device could be a separate component. The imaging device 212 could be mounted on excavating equipment (e.g., the stick, boom, cab, etc.), equipment associated with the excavating equipment (e.g., a haul truck), other earth working equipment, dredging ship and/or an independent support. The imaging device may be an optical camera, a thermal or infrared imaging camera, night vision camera, an x-ray camera, or surface characterization device, such as a LiDAR device, a laser range finder, an ultrasonic sensor, a 3D Flash camera (time of flight camera), 3D point representation device, and a photogrammetry device or some combination. In one example, a digital representation may be captured by an imaging device 212 of the computing device 114. The image may be a digital photographic static image, a video stream, or an electronic representation of the ground engaging product based on a scan or other way of capturing information related to at least a relevant dimension of the ground engaging product 103. Also, computing device 114 may include data stores for storing image data to be analyzed.

It is noted that various connections between elements are discussed in the following description are general and, unless specified otherwise, may be direct or indirect, wired or wireless, and that the specification is not intended to be limiting in this respect. Elements of the environment may be connected to an electronic network 109 over which they communicate with one another. For example, environment 100 may be configured as a “distributed”, “virtual”, or a “cloud” infrastructure where processing and memory is distributed across multiple platforms or portions thereof. In other examples, the various components of environment 100 may be co-located or may be distributed geographically.

Examples of a communication network 109 include intranets, internets, the Internet, local area networks, wide area networks (WAN), mine site networks, wireless networks (e.g. WAP), secured custom connection, wired networks, virtual networks, software defined networks, data center buses and backplanes, or any other type of network, combination of network, or variation thereof. Such wireless networks may include, for example, a cellular network, such as a 2nd Generation (2G™), Generation (3G™), a 3rd Generation Long Term Evolution (LTE™) network, a 4th Generation (4G™) network; or a 5^{th} Generation (5G™); or a WiMAX™ network(e.g., IEEE 802.16 protocol); a picocell or femtocell network (e.g., a Bluetooth™ or other unlicensed radio spectrum network); or other type of electronic communication network 109. The wireless network communication interface 109 may include any components known in the art necessary to communicate on such network(s). Various protocols such as TCP/IP, Ethernet, FTP, and HTTP may be used in establishing the communications links. Communication network 109 is representative of any network or collection of networks (physical or virtual) and may include various elements, such as switches, routers, fiber, wiring, wireless, and cabling to connect the various elements of the environment 100. Communication between environment components and other computing systems, may occur over communication network 109 or networks and in accordance with various communication protocols, combinations of protocols, or variations thereof. The aforementioned communication networks and protocols are well known and need not be discussed at length here. It should be appreciated that the network 109 is merely exemplary of a number of possible configurations according to examples of the present technology.

At a location 102, such as an earth working site, a sea bed, a dredge ship, or a mining site, there may be a user 112, a computing system 114, and an earth working machine 110 having wear components 103. The location 102 may be anywhere in which the earth working machine 110 and a user 112 may be present. The computing system 114 includes, in one example, a digital camera 212 capable of capturing a digital representation of the wear part 103 of the earth working machine 110 as data that is further processed to determine a dimension of the wear component 103 and an amount of wear.

The earth working machines 110 may be, for example, draglines, cable shovels, face shovels, hydraulic excavators, rippers, dredge cutters, etc. Examples of wear components 103 are ground-engaging products such as points, tips, adapters, intermediate adapters, shrouds, picks, blades, wear plates, truck trays, etc.

In one example, the user 112 may be the operator of the earth working machine 110. The user 112 may be an autonomous vehicle, a partial autonomous vehicle, a non-autonomous vehicle, a robot, a drone, a truck, or a tool. The user 112 may be a technician, repair person, or other person associated with machine 110. The particular nature of user 112 is not critical though there are benefits associated with the user being the operator of the machine. The user 112 may be any person who uses the disclosed systems and methods to determine a dimension of the wear part and the amount of wear of the wear part of earth working machine 110. The user 112 may carry the computing system 114, such as, an edge device or mobile device 114 and use it to capture a digital representation of a wear part 103 of machine 110. Which, in turn, is used to determine and/or display a dimension of the wear part and/or the amount of wear. Such determinations may be made separately and communicated back to the mobile device 114 either wirelessly or wired.

In one implementation, the user 112 uses an imaging device 212 as a component of the computing system 114 to capture a digital representation of a wear part 103 of machine 110, such as a tooth, which is then used to determine a dimension, e.g. its length, width, or a distance between its end and a reference point, and its amount of wear. To that end, computing system 114 may embody any type of portable computing device equipped or associated with an imaging device function (or other imaging device) and configured to communicate data over network 109.

Image processing system 104 may represent a computing system configured to provide the disclosed service for determining part dimension and wear as well as other related services; one or more of these operations could also be conducted by the processing system 114. As explained below in more detail, image processing system 104 may have any number or combination of computing elements enabling it to communicate, store, and process data to carry out the disclosed techniques. For example, image processing system 104 may embody a server computer or a collection of server computers configured to perform the described techniques. In another example, the image processing system 104 may be a part of the computing system 114. In another environment, image processing system 104, for example, may receive digital representations of wear parts from mobile device 114 over network 109. Image processing system 104 may then process the images to determine the dimension and an amount of wear of the parts and return results of the processing to mobile device 114 or client-side system 108 over network 109. The image processing system 104 may store dimension and/or wear data it determines in a database(s) or memory(s) and update the wear profiles of the various types of wear products being monitored. The mobile device 114 may store the captured data until it can connect to the network and/or processing system 104. The image processing system 104 may be or a part of a convolution neural network (CNN) used to analyze and machine learn from image data. CNN uses an independent optimization of filters of images that are not hand-engineered. Other neural networks that use traditional machine learning decision tree algorithms are also envisioned being used.

The image processing system 104 may be single-user or multi-user. A single user may be an autonomous source, like a neural network. In the multi-user environment, multiple authorized users may have access to data captured, as discussed herein, by any authorized user 112 at the site. Multiple users may be linked together by the system such that information and data captured by one user is accessible and usable by another user operating at different times, on different machines, at different mine sites, etc. User 112 may be a different user for the image processing system 104. The information and data may also be shared to remote locations (e.g., the client-side computing system 108, product supplier, mobile device 114, etc.) where it may be assessed, i.e., from one or all the users of mobile devices, to determine wear, wear rate, remaining life, abrasiveness of the ground, size of earthen material being moved, product and/or operation problems, etc. The information and data may optionally be used offline to make profile assessments, end of life predictions, degree of wear, worksite mapping and/or the like. The results from such assessments can optionally be provided back to the mobile device 114, client-side computing system 108 or other system.

Alert notification system 106 may represent a computing system configured to provide an alert(s) when an end-of-life of a ground engaging product is at hand or approaching, when a ground engaging product has becomes damaged, cracked or lost, or if the ground engaging product should be rotated (e.g. outer position ground engaging products swapped with central position and/or the ground engaging products flipped over top-to-bottom). Alert notification system 106 may have any number or combination of computing elements enabling it to communicate, store, and process data to carry out the disclosed techniques. The computing system 114 may be in communication with the alert notification system 106 to allow the user 112 to issue an alert prior to determining wear of a wear part. For example, a non-monitored wear part may include pits, holes, breakage, damage, unsafe sharpness, cracking, deformation, unproper locking, excessive wear, etc.

Image processing system 104 may interact and communicate with elements of environment 100, such as mobile device 114 and/or client-side system 108, to process a captured digital representation of a wear part of machine 110 and determine a dimension and its wear. In one example, the image processing system 104 may also communicate with the alert notification system 106 when it is determined that a wear component 103 of the earth working machine 110 is sufficiently worn. The alert notification system 106 issues an alert to the client-side system 108, so that the client may act if warranted, such as, putting the machine 110 down for maintenance.

In some instances, aspects of the disclosure may be implemented using computer-executable instructions, such as program modules, being executed by a computer. Such program modules may include routines, programs, objects, components, data structures, or the like that perform particular tasks or implement particular abstract data types. Some aspects of the disclosure may also be implemented in distributed computing environments where tasks are performed by remote processing devices that are linked through a communications network. In such a distributed computing environment, one or more program modules may be located in both local and remote computer storage media including non-transitory memory storage devices, such as a hard disk, random access memory (RAM), and read only memory (ROM).

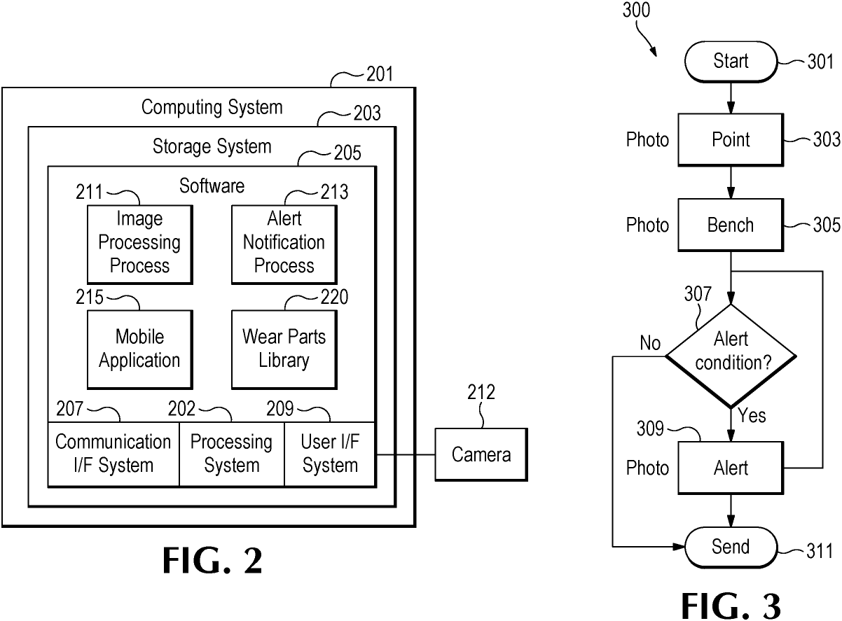

FIG. 2 is a schematic diagram illustrating an example system of the components of the environment 100, including the mobile device 114 used to monitor one or more ground-engaging products. Computing system 201 contains computing components that enable it to transmit/receive, process, and store data. Examples of a computing system 201 include, but are not limited to, server computers, mobile devices, web servers, cloud computing platforms, and data center equipment, as well as any other type of physical or virtual server machine, container, and any variation or combination thereof. Computing system 201 may be implemented as a single apparatus, system, or device or may be implemented in a distributed manner as multiple apparatuses, systems, or devices. Information and/or data received from the can be processed by processing system 202, which could be part of the computing system 114, the earth working machine 110, image processing system 104, alert notification system 106, client-based system 108, handheld device, mobile device, and/or remote device(s).

Computing system 201 includes, but is not limited to, processing system 202, storage system 203, software 205, communication interface system 207, and user interface system 209. Processing system 202 is operatively coupled with storage system 203, communication interface system 207, and user interface system 209, and/or imaging device 212.

Computing system 201 may employ central processing units (CPUs) or processors to process information. Processing system 202 may be implemented within a single processing device but may also be distributed across multiple processing devices or sub-systems that cooperate in executing program instructions. Examples of processing system 202 include programmable general-purpose central processing units, special-purpose microprocessors, programmable controllers, graphical processing units, embedded components, application specific processors, and programmable logic devices, as well as any other type of processing devices, combinations, or variations thereof. Processing system 202 may facilitate communication between co-processor devices. The processing system 202 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing.

In another implementation, processing system 202 may expedite encryption and decryption of requests or data. A processing system 202 may comprise a micro-processor and other circuitry that retrieves and executes computer instructions, programs, applications, and/or software 205 from storage system 203. Processing system 202 executes program components in response to user and/or system-generated requests. One or more of these program components may be implemented in software, hardware or both hardware and software 205. Processing system 202 may pass instructions (e.g., operational and data instructions) to enable various operations.

Communication interface system 207 may include communication connections and devices that allow for communication with other computing systems over communication networks. For example, communication interface system 207 may be in communication with a network 109.

Examples of connections and devices that together allow for inter-system communication may include network interface cards, antennas, power amplifiers, RF circuitry, transceivers, and other communication circuitry. Communication interface system 207 may use various wired and wireless connection protocols such as, direct connect, Ethernet, wireless connection such as IEEE 802.11a-x, miracast and the like. The connections and devices may communicate over communication media to exchange communications with other computing systems or networks of systems, such as metal, glass, air, or any other suitable communication media. The aforementioned media, connections, and devices are well known and need not be discussed at length here.

The communication interface system 207 can include a firewall which can, in some implementations, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, for example, to regulate the flow of traffic and resource sharing between these varying entities. Other network security functions performed or included in the functions of the firewall, can be, for example, but are not limited to, intrusion-prevention, intrusion detection, next-generation firewall, personal firewall, etc., without deviating from the novel art of this disclosure.

User interface system 209 facilitate communication between user input devices, peripheral devices, and/or the like and components of computing system 201 using protocols such as those for handling audio, data, video interface, wireless transceivers, or the like (e.g., Bluetooth®, IEEE 1394a-b, serial, universal serial bus (USB), Digital Visual Interface (DVI), 802.11a/b/g/n/x, cellular, etc.).

User interface system 209 may include card readers, fingerprint readers, joysticks, keyboards, microphones, mouse, displays, headsets, remote controls, retina readers, touch screens, sensors, and/or the like. Peripheral devices may include antenna, audio devices (e.g., microphone, speakers, etc.), external processors, displays, communication devices, radio frequency identifiers (RFIDs), scanners, printers, storage devices, transceivers, and/or the like. As an example, the user interface system 209 may allow connection to a surface characterization device or imaging device 212.

User input devices and peripheral devices may be connected to the user interface 209 and potentially other interfaces, buses and/or components. Further, user input devices, peripheral devices, co-processor devices, and the like, may be connected through the user interface system 209 to a system bus. The system bus may be connected to a number of interface adapters such as the processing system 202, the user interface system 209, the communication interface system 207, the storage system 205, and the like.

Imaging device 212 may embody any image-detection device(s) mounted to or otherwise associated with the computing device 114 that captures an image within a field of view of an image sensor of the imaging device 212. For example, an optical camera 212 may be a conventional visual-light-spectrum camera device mounted on mobile device 114 and operable to capture and store a digital representation in response to user 112 providing appropriate input to user interface 209, such as pressing an interactive button displayed on a touch screen. Imaging device 212 may have an embedded image sensor, such as a charge coupled device (CCD). The sensor may convert incident electromagnetic radiation focused thereon by a lens into electrical charges for storage as a digital representation. In other examples, imaging device 212 may be an infrared camera device, a night vision device, a 3D point representation device, a LiDAR device, a laser range finder, an ultrasonic sensor, a 3D flash camera, or an X-ray camera device. As another example, imaging device 212 may embody any type of device configured to capture electromagnetic radiation as a digital representation.

Storage devices or system 203 may employ any number of magnetic disk drive, an optical drive, solid state memory devices and other storage media. Storage system 203 may include volatile and nonvolatile, removable, and non-removable media implemented in any method or technology for storage of information, such as computer readable instructions, data structures, program modules, or other data. Examples of storage media include tangible, non-transitory storage devices or systems such as fixed or removable random access memory (RAM), read only memory (ROM), magnetic disks, optical disks, flash memory, virtual memory and non-virtual memory, magnetic cassettes, magnetic tape, solid state memory devices, magnetic disk storage or other magnetic storage devices, or any other suitable processor-readable storage media. In no case is the computer readable storage media a propagated signal. The storage system 203 may employ various forms of memory including on-chip CPU memory (e.g., registers), RAM, ROM, and storage devices. Storage system 203 may be in communication with a number of storage devices such as, storage devices, databases, removable disc devices, and the like. The storage system 203 may use various connection protocols such as Serial Advanced Technology Attachment (SATA), IEEE 1394, Ethernet, Fiber, Universal Serial Bus (USB), and the like.

In addition to computer readable storage media, in some implementations storage system 203 may also include computer readable communication media over which at least some of software 205 may be communicated internally or externally. Storage system 203 may be implemented as a single storage device but may also be implemented across multiple storage devices or sub-systems co-located or distributed relative to each other. Storage system 203 may comprise additional elements, such as a controller, capable of communicating with processing system 702 or possibly other systems.

The storage system 203 may be a database or database components that can store programs executed by the processor to process the stored data. The database components may be implemented in the form of a database that is relational, scalable, and secure. Examples of such database include DB2, MySQL, Oracle, Sybase, and the like. Alternatively, the database may be implemented using various standard data-structures, such as an array, hash, list, stack, structured text file (e.g., XML), table, and/or the like. Such data-structures may be stored in memory and/or in structured files.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. Computer-executable instructions stored in the memory may include an interactive human machine interface or platform having one or more program modules such as routines, programs, objects, components, data structures, and so on that perform particular tasks or implement particular abstract data types. For example, the memory may contain operating system (OS), modules, processes, and other components, database tables, and the like. These modules/components may be stored and accessed from the storage devices, including from external storage devices accessible through an interface bus.

Software 205 (including an operating system, an image processing process 211, an alert notification process 213, a mobile application 215, and a wear part library 220) may be implemented in program instructions and among other functions may, when executed by processing system 202, direct processing system 202 to operate as described with respect to the various operational scenarios, sequences, and processes illustrated herein. For example, software 205 may include program instructions for implementing the processes described herein.

Operating software may embody any type of software operating environment for a computing device 201 in which one or more applications executes. For example, mobile operating platform 216 may embody the Nokia Symbian™ operating environment, the Apple IOS™ operating environment, the RIM Blackberry™ operating environment, the Google Android™ operating environment, the Windows Mobile™ operating environment, or another graphical operating environment configured to execute on a mobile computing device and support execution of mobile applications. Other operating systems are also possible.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 205 may include additional processes, programs, or components, such as operating system software, virtualization software, or other application software. Software 205 may also comprise firmware or some other form of machine-readable processing instructions executable by processing system 202.

In general, software 205 may, when loaded into processing system 202 and executed, transform a suitable apparatus, system, or device (of which computing system 201 is representative) overall from a general-purpose computing system into a special-purpose computing system customized to provide wear part analysis and alert notifications. Indeed, encoding software 205 on storage system 203 may transform the physical structure of storage system 203. For example, if the computer readable storage media are implemented as semiconductor-based memory, software 205 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

The image processing process 211 is used to process the information generated from the imaging device 212 that, e.g., captures data and is converted to a digital two-dimensional image of the product. The image may or may not be specifically bounded by a boundary or outline in the capture process. The image processing process 211 may be a web-based application, a neural network, or executed in software stored at an image processing server 104. The image processing process 211 may use a template specific to the wear component 103 whose image is received. The template has predetermined reference points that the process 211 will use to measure a dimension (e.g. overall length, width, or a distance between its end and a reference point,) of the wear component 103. Since the image comes in a predetermined orientation and alignment, the scaling of the image is known (e.g. non-random) and the template is overlaid the digital representation and the dimension of the wear component 103 is determined. The difference from the previous measurement determines the wear of the wear component 103. The determined dimension may be stored in storage system 203.

In another example, the image processing process 211 processes a non-bounded image by machine learning to detect the boundaries of the wear part, e.g. a specific point, a specific adapter, a specific shroud, and the like, and create a boundary box around the wear part. The image processing process may incorporate a neural network that is input several images of the same wear part at varying wear states to determine a tight fit boundary box over the wear component for training the neural network. The image processing process could also be trained to boundary the box around a known reference point, such as the lifting eye or the lock. The process can be repeated with other versions of points, adapters, shrouds, and the like. With no known intrinsic knowledge of how far away the imaging device was to take the image, a dimension can be determined from a derived equation involving the aspect ratio (e.g. width over height of the point if measuring the length of the point, the distance between known reference points on the part, etc.). The image processing process 211 uses an algorithm to derive an equation from previous determined dimensions using the template as described above from the bounded images to learn and map a correlation between the aspect ratio and the determined dimension. Though other configurations may be possible, e.g. actually measuring the dimension associated with an image without use of the template. The algorithm using the known variable that the height of the box or the length of the specific wear component decreases with use and the width changes at a slower rate. The machine learning repeats (e.g. through regression) until an equation is derived that correlates the given aspect ratio (pixels/pixels) to an output of dimension (e.g. in inches) successfully. The derived equation may be linear, quadratic, radical, exponential, and/or rational.

In another example, the image processing process 211 processes a non-bounded image by machine learning to detect the outline of the wear part, e.g. a specific point, a specific adapter, a specific shroud, etc. The image processing process may incorporate a neural network that is input several images of the same wear component at varying worn states to determine a tight fit outline over the wear component for training the neural network. The process can be repeated with other versions of points, adapters, shrouds, and the like. At an inference time when a segmentation map is returned there is no known intrinsic knowledge of how far away the imaging device was to take the image. The outline of the point as an image is scaled to a normalized area equal to a set of known wear profile outlines. In this example, it is the outline of the wear part that is compared with a known wear outline for a particular wear component 103. The image pixel area is scaled to the known outlines for comparison sake. The comparison determines the dimension, as the known wear profile outlines have the dimension that is known.

In a further example, the image processing process 211 processes an entire video of at least two (or other arrangement) wear parts to build a 3D model of the at least two wear parts through photogrammetry. The video could be taken from a top, angled, or front approach. The video being a series of still images that are constructed together through image based modeling to form the 3D model. The imaging device also sending location data on where the imaging device is located with relation to the filmed row of wear parts and the orientation of the photo. Once the 3D model is built, regions of interest are segmented in 3D image segmentation, e.g. one region of interest is the point, another region of interest is the adapter, and so forth. The 3D image segmentation may be machine learned, e.g. through training a convolutional neural network to create an automated segmentation process. The images need to be scaled for a dimension determination to be made. Known distances may be used to determine the dimension of the tooth in the model. For example, a known distance may be a shroud length, shroud width, wear cap width, wear cap length, a distance between two wearable points, a distance between two shrouds, etc. With the known distances the pixel length can be scaled and a length of a particular region of interest, e.g. a point, can be determined.

In yet another example, the image processing process 211 processes a non-bounded image of at least two points and a wear part (e.g., a shroud) by machine learning to detect the boundaries of the two points and the wear part and create a boundary box around the wear part. The dimension, e.g. its length, width, or a distance between its end and a reference point is determined by a known distance divided by the pixels within that known distance. For example, a known distance may be a shroud length, shroud width, wear cap width, wear cap length, a distance between two points, a distance between two shrouds, etc. With the known distances the pixel length can be scaled and converted to a length of the two points. The dimension can be further used to determine wear and estimated life remaining. This helps to predict the time of changeover and/or to plan preventive maintenance for the equipment.

In some examples, the image processing process 211 may also rotate a photo in the proper orientation for analysis to occur, e.g. rotate about a vector normal to the x-y plane. In other examples, the image processing process 211 may be able to detect multiple wear components, either aligned, ramped, or unequal to each other.

The image processing process 211 may also receive a digital representation of a work bench or working area (e.g., the earthen bank being excavated at a mine). The image processing process 211 may predict the remaining life of the ground engaging product using the work bench to determine: fragmentation, material size, hardness, material type, geometric properties, location in mine, and the like. The work bench photo shows the physical material being worked on and the process 211 uses this visual to determine future wear of the product. The work bench photo may also be used to verify the time of day the image was captured. The image may be combined with other data, such as geology characteristics of the material or spectrography. Several measurements can be called upon to display a daily or weekly wear of the wear component. For example, in one example, the calculation may be a regression or other analysis based on installation date and each of the dimensions measured on multiple dates to the end of life. In another example, the end-of-life calculation may be based on a look-up table that correlates a dimension (e.g., e.g. its length, width, or a distance between its end and a reference point,) of a particular ground engaging product to an extent of wear and an amount of days remaining to end-of-life for the ground engaging product. The end-of-life calculation at any given time may incorporate prior measurements or calculations made from one or more prior points in time. The analysis may include seasonal, location, and positional factors as inputs to the analysis. This portion of process 211 and/or process may be machine learned, such that iterative predictions are compared to actual data for the day predicted, in this way a more accurate prediction model may be generated. The client-based computing service 108 or supplier may thereby determine demand and predict potential need to replenish ground engaging products to the site. With work bench data from multiple sites and customers, the supplier may also better determine the best range of ground engaging product dimensions that correlate to increased performance.

The image processing process 211 may produce an alert indication when a specific product is close to needing replacement or rotation. In addition, the image processing process 213 may produce an alert if the wear product 103 has been lost or if the product has been worn so that it is greater than, equal to, or less than the recommended minimum wear profile. In addition, the image processing process 211 may provide an indication of current flaws or predictions of future flaws that may lead to loss, damage, or failure of the product that may lead to a reduction in productivity and/or equipment downtime.

The alert notification process 213 receives an indication from either the image processing process 211 or the mobile application 215 that an alert should be issued. The indication includes data for the wear part 103 identification, wear part location on the earth working equipment, the time of the alert, and the requestor. This data is converted to a portable network graphics file (or other media) and attached or embedded into an email. The email is directed to technicians or maintenance team and/or transmitted to the client-side system 108.

Mobile application 215 may embody an application configured to execute on mobile operating platform to perform functions that enable the image processing system 104 to determine the dimension of the wear part and the amount of wear of wear parts of machine 110 based on digital representations captured with imaging device 212. In another implementation, the mobile application 215 may embody an application configured to execute on an augmented reality headset. The mobile application 215 includes programmable instructions or logic to allow a user to select an earth working equipment/machine 110. The earth working equipment may be stored with the accompanying type of ground engaging products attached to it. The mobile application 215 includes an image capture process that uses the imaging device 212. The mobile application 215 may not allow the function of the imaging device if the angle of the photo (or other image) and/or device is too steep to be useful. The mobile application may only allow certain angles for the image capture process to initiate in using the imaging device to capture an image. The software may adjust a guideline or frame for the imaging device based on the type of ground engaging products attached to the earth working equipment. The mobile application 215 may not store each type of ground engaging product in its memory, so it may call to a wear part library 220. The wear part library 220 may be a database that stores wear part information, such as the guidelines specific to each type of ground engaging product and templates for each type of ground engaging product. In one example, the wear parts information may be indexed by machine model, part name, and/or part model number, so that wear parts library 220 can be queried to determine the necessary guideline. The wear part library 220 may also include wear profiles that may define an amount of wear as a function of remaining useful wear life left on the wear component 103. The wear part library 220 may include wear part outline geometry at given dimensions, so that the image processing process may use these models in comparison with a scaled image. This information may be called by the programmable logic from the image processing process 211 to aid in determining useful remaining life left. For example, operators may wish to know when a wear component 103 is at 65% useful life left as this may aid in determining a rotation of wear components 103.

In one example, the guideline may be displayed as an outline of the ground engaging product 103 on the mobile application interface. In this example, the user 112 may orient the imaging device 212 such that the ground engaging product is aligned with the guideline. The guideline aids the user and improves the speed of the inspection by reducing the number of photos taken. The mobile application may further include a scanning function that would auto-detect the back end of the wear component 103 and/or the wear surface to automatically align the image within the guideline.

The mobile application 215 also allow for alerts to be input. If an alert is deemed necessary by the user 112, then the programmable logic will call to the imaging device 212 to obtain an image of the affected area. This digital representation is sent with the data as described above to the alert notification system. The mobile application 215 allows the user to obtain an image of the work bench, which is optional. The capture image of the ground engaging product 103 and/or the work bench are transmitted to the image processing system 211. The user 112 may periodically utilize the mobile device 114 to perform routine checks of the ground engaging products 103 associated with the excavating machine 110.

With reference to FIG. 3, a flowchart illustrating an exemplary process or method for capturing an image for a single wear part and providing an alert indication. Process 300 may be implemented in program instructions in the context of any of the software applications, modules, components, or other such programming elements deployed in a computing system 201. The program instructions direct the underlying physical or virtual computing system or systems to operate as follows, referring parenthetically to the steps.

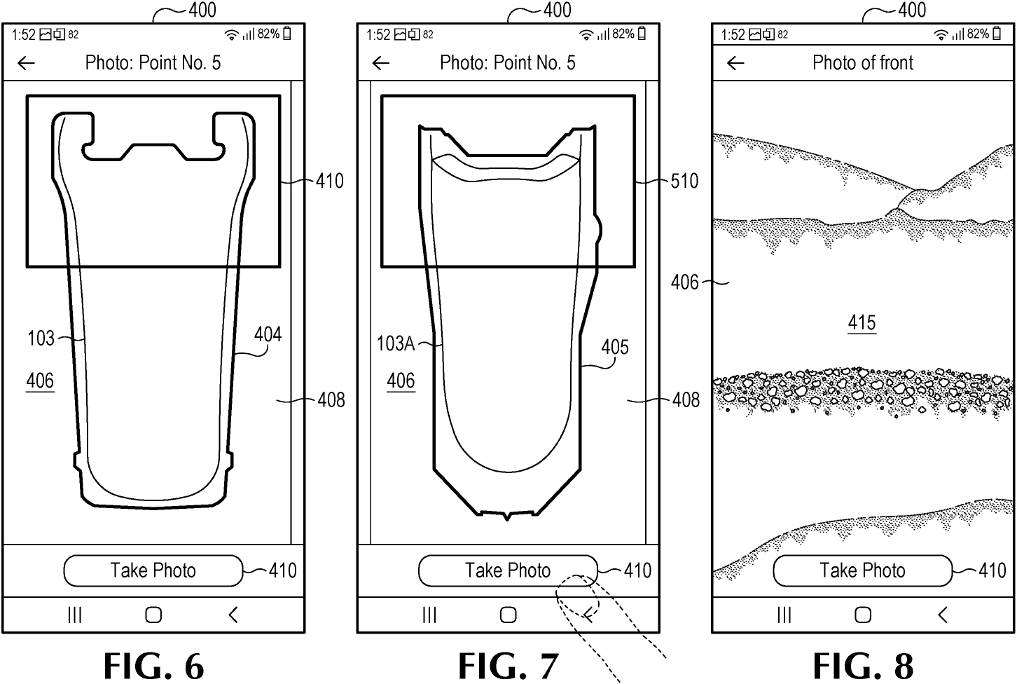

To begin, a user 112 selects the earth working equipment that they are to inspect (Step 301). The selection process can take a variety of forms such as the operator selecting the equipment they will begin to operate, a pre-planned inspection process, selection based on previous monitoring, autonomously through programming, etc. Next, a user 112 positions themselves (or itself) proximate (e.g., above or adjacent) a ground engaging product. In one example, the imaging device may be positioned generally parallel to the ground engaging product, so as to align a top of the ground engaging product within a guideline and then taking an image (Step 303). In other examples, the imaging device may be positioned generally at an angle, e.g. 45 degrees from a horizontal plane. In this step, in one example, the image alignment may be emphasized on the back end of the ground engaging product (shown as a red square in FIGS. 6-7). The imaging device may scan the wear component, video the wear part, and/or capture an image of the wear part. Next, the imaging device can optionally be directed at a work bench or work area, and an image taken of this area (Step 305). Next, the image or video is processed to determine how worn the tooth is (Step 306). Next, determine if there are any alert conditions to be reported (Step 307). If an alert condition is recognized, then transmit an alert indication to the alert notification system 106 (Step 309). The alert condition may require an image to be captured, if so then this is sent with the alert indication. The alert condition may include pits, holes, breakage or damage, sharpness, cracking, deformation, unproper locking, excessive wear on a non-monitored part (e.g. wing shrouds). If no alert condition exists, then the captured images are transmitted to the image processing system 104 (Step 311). In another example, only the ground engaging product image is transmitted. In another implementation, the image is not transmitted, but is instead processed by the image processing system 104 housed in the computing system 114.

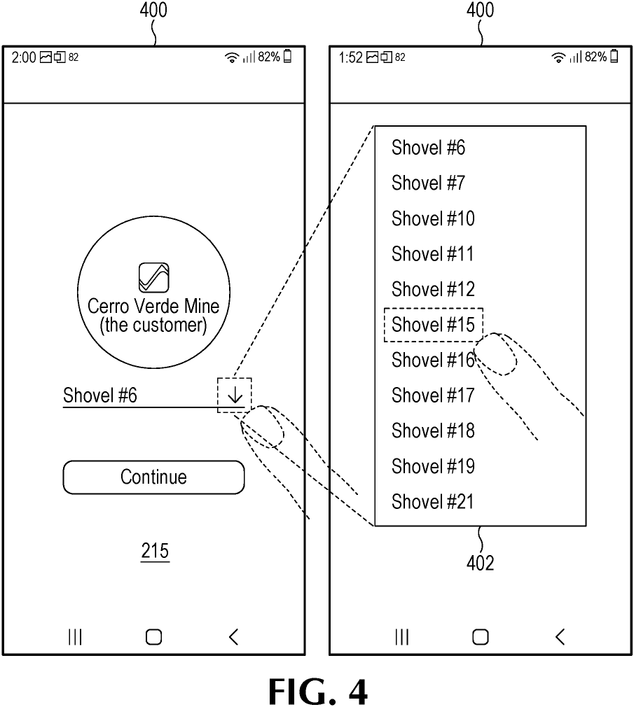

With reference to FIG. 4, an exemplary display 400 of computing device 114 can present an implementation of an image-capture graphical user interface (GUI) for the mobile application (“app”) 215. In different implementations, the mobile application 215 can be configured to display the GUI and various user interface elements, features, and controls to facilitate capturing images via an imaging device. The GUI display 400 may be displayed on an output device when user 112 launches the mobile application 215 stored on mobile device 114 and processor 202 executes the same. In another example, the GUI display 400 may be displayed on output device when user 112 accesses a web-based application of the image processing system 104 over network 109 using the device’s web browser.

Starting with the FIG. 4 example, the user 112 may specify the particular job site or mine, the machine in question, the type of ground engaging product (or ground engaging product (GET)) and the position of the ground engaging product on the machine. This process may be accomplished in a variety of ways including manual choice, pre-planned schedule, by programmable logic based on earlier monitoring, etc. In one example, these parameters may be edited or selected using, for example, drop down menus 402 on the GUI display 402. The information related to the ground engaging products, earth working equipment, working site, etc. may be provided by sensors in the ground engaging products and/or the earth working equipment, and/or inputted by scanning a code provided on the ground engaging products and/or earth working equipment. Once the user 112 specifies selects the appropriate earth working equipment, the application loads the appropriate guideline, and the user 112 may proceed to take images. Other configurations are possible, such as an application without a GUI, and selections are input.

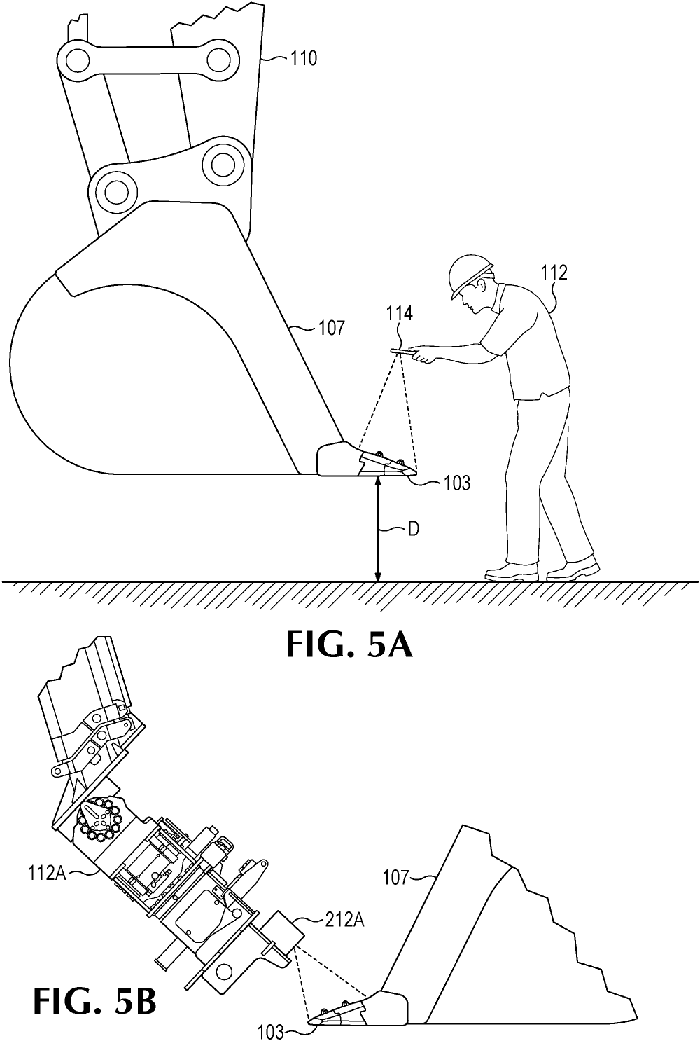

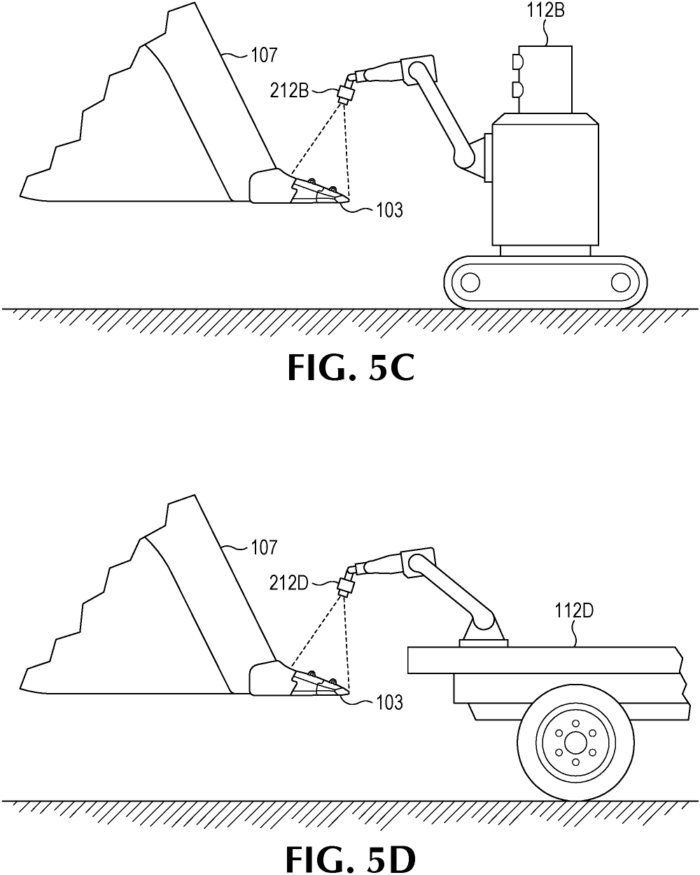

With reference to FIG. 5A, a user 112 may orient mobile device 114 above, e.g., in front, or angled (e.g. 45 degrees) from a ground engaging product 103. In one example, the user 112 is a tool 112A having an imaging device 212A (FIG. 5B) that is operated manually, autonomously or partially by both. In other examples, a tool may include an imaging device 212A that is operated by a user. The tool 112A may orient the imaging device 212 above, in front, or angled from the ground engaging product 103. In the illustrated example, the tool 112A may be used to install and/or remove wear parts. As examples, the tool may be as described in US Patent No. 11,015,324 entitled, “WEAR ASSEMBLY REMOVAL AND INSTALLATION”; US20160237640 entitled “MONITORING GROUND-ENGAGING PRODUCTS FOR EARTH WORKING EQUIPMENT”; US20170356167 entitled, “HANDLING SYSTEM FOR GROUND-ENGAGING WEAR PARTS SECURED TO EARTH WORKING EQUIPMENT” US20190360180, entitled, “MANIPULATOR, SYSTEM AND PROCESS OF OPERATING THE SAME”; or WO2020232082 entitled “MONITORING TOOL, SYSTEM AND METHOD FOR EARTH WORKING EQUIPMENT AND OPERATIONS”, each of which are incorporated by reference herein. The tool 112A may have a manipulator (not shown), a controller (not shown) that maneuvers the manipulator, and an auxiliary tool. In some cases, that auxiliary tool may have one or more of 3-axis articulation, gripping features, lock removal features, vibratory features, and the like, in addition to an imaging device.

In another example, the user 112 is a robot 112B having an imaging device 212B (FIG. 5C). The robot 112B may, e.g., orient the imaging device 212B above, on the horizon (e.g. in front), or angled from the ground engaging product 103. In a further example, the user 112 is a vehicle 112D having an imaging device 212D (FIG. 5D). The vehicle 112D may orient the imaging device 212D, e.g., above, in front, or angled from the ground engaging product 103.

In one example, the user 112 will align the imaging device 212 to the top of the wear part 103, so that a wear part (e.g., a point 103) is within a visual guideline 404 to capture a digital representation thereof (FIGS. 6-7) for the purpose of the mobile device 114 and/or image processing system 104 processing the digital representation to determine the dimension and wear of the wear part 103; however, the visual guideline could be omitted. The earth working machine 110 is non-operational, and a bucket 107 is preferably positioned a distance D off a ground though the bucket could be on the ground (FIG. 5A). In the illustrated example, D is equivalent to 50 cm but other spacings are possible. The user 112 can quickly do this inspection in-between shifts of operation of the earth working equipment which speeds up the inspection and more earth working equipment can be inspected and more results can be analyzed. In this case, there does not need to be a separate down time because of the inspection, it can be done between shifts of the operators when the machines are shut down and tagged out to permit changing of the operators.

As illustrated in the FIGS. 6-7, GUI display 400 may include an image capture window 406 that displays a field of view of imaging device 212 within a visual guideline 404. In this example, the image is a top view image of the wear member 103 that is associated with machine or equipment ID “Pala/Shovel 15” (FIG. 4). The background 408 of the window 406 may have a portion blacked out as illustrated but other arrangements are possible (e.g. blurred, augmented reality, and the like). In another example, this may be a soft focus, so that the operator can focus on aligning the wear part 103 to capture the wear part 103 within the visual guideline 404. With the visual aid of the frame or visual guideline 404, for example, the user 112 at mine site 102 may orient mobile device 114 and imaging device 212 so that a wear part of earth working machine 110 is within the visual guideline 404 (FIGS. 5A-5D). Since the wear part 103 wears at the front or working end 412 more than the back or mounting end 414, the alignment is increased when the user 112 aligns the image along the rear end of the wear part 103 (shown as a box 410, 510 in FIGS. 6-7). GUI display 400 may further include a capture image interface element 410, such as an interactive button, “Tomar foto/Take Photo.” When the user 112 selects capture image interface element 410, processor 202 may control imaging device 212 to capture the digital representation displayed in image capture window 406. Processor 202 may also store the digital representation in storage device 214. FIG. 7 shows a second example of image capture window 406 with a guideline or frame 405 for a different type of wear component than shown in FIG. 6, e.g. a point 103A.

In another implementation, where the imaging device takes an image of two or more wear components, the visual guideline 404 may be for two or more wear components 103. For example, the guideline 404 may create a frame for the entire row of teeth on a small bucket. In some implementations, only a single wear component 103 will be monitored, but it is envisioned that multiple wear components will be monitored. In such examples, where one wear component is monitored, the wear component that receives the highest amount of wear is a key candidate for monitoring, such as the central position. The central position erodes faster than the outer positions (e.g. for a bucket with nine teeth, position five would be the central position to be monitored). In another implementation, each of the wear components secured to the digging edge of the earth working equipment could be monitored. In such a case, the operator would follow the steps associated with FIGS. 4 and 5 for each wear component. At the end, a photo of the work bench may also optionally be taken.

As illustrated in the FIG. 8, GUI display 400 may include an image capture window 406 that displays a field of view of the imaging device 212 shown in the image capture window 406. The image capture window 406 is illustrated as taking up a substantial portion of the GUI display 400. The user 112 at mine site 102 may orient mobile device 114 and imaging device 212 so that a work bench 415 (e.g. current state or fragmentation of area being worked) is within the visual field of the imaging device 212 shown in the image capture window 406. When the user 112 selects capture image interface element 410, processor 202 may control imaging device 212 to capture the digital representation displayed in image capture window 406. Processor 202 may also store the digital representation in storage device 214.

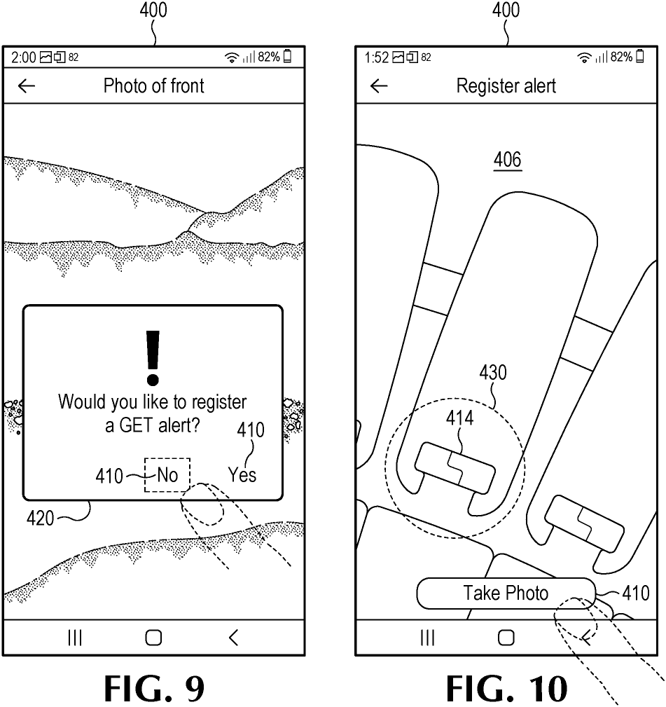

As illustrated in the FIG. 9, GUI display 400 may optionally include a pop-up window 420 that displays a request to register an alert condition or not. GUI display 400 may further include a responsive interactive button 410. When user 112 selects a positive confirmation of an alert condition by pressing the “Yes” button 410, processor 202 may control imaging device 212 to allow the user 112 to capture the digital representation displayed in image capture window 406. The image capture window 406 is illustrated as taking up a substantial portion of the GUI display 400. In the illustrated example, an alert condition 430 is emphasized (encircled) in FIG. 10. In this example, the alert condition 430 is a breakage of the wear component 103 behind a locking mechanism 414. When user 112 selects capture image interface element 410, processor 202 may control imaging device 212 to capture the digital representation displayed in image capture window 406. Processor 202 may also store the digital representation in storage device 214. The mobile app 215 may allow for a description of the alert condition to be input. Once completed, the alert condition image is transmitted to the alert notification system 106 and further onto the client-side computing system 108 as an email attachment. If there is no alert condition 430, then the user will select the “No” interactive button 410.

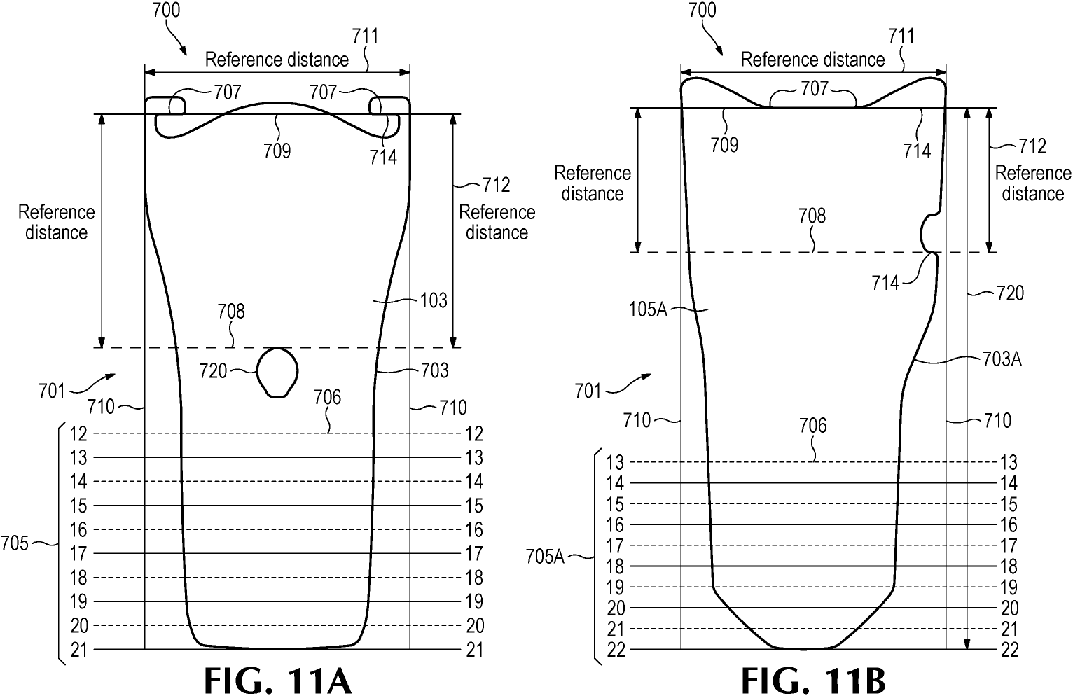

Referring to FIG. 11A, an exemplary display 700 of computing device 114 can present an implementation of an image processing graphical user interface (GUI) 701. The image processing process may be a component of the mobile application 215 or a separate software or part of image processing device 104. In different implementations, the image processing application 702 can be configured to display the GUI 701 and various user interface elements, features, and controls to facilitate dimension determination of a wear component 103. The GUI display 700 may be displayed on an output device or display when user 112 launches the mobile application 215 stored on mobile device 114 and processor 202 executes the same. In another implementation, the GUI 701 may be displayed on output device when user 112 accesses a web-based application of the image processing system 104 over network 109 using the device’s web browser.

GUI 701 may further include a dimension (e.g. a wear part’s length, width, or a distance between wear part’s end and a reference point,) indicator template element 705 that indicates a length of the wear part 103 at certain intervals, as determined from the overlay of the template element 705 over the digital representation 703 of the wear component 103. The image processing process 211 loads the appropriate template 705 for the wear component and the received wear component image 703. The template 705 is unique to each specific wear component 103. The information concerning the type of wear component 103 and the position on the earth working equipment may be received with the image 703. The image processing process 211 may call to a wear part library 220 to acquire the appropriate template 705 for the received image.

In one example, the dimension indicator template 705 may include a ruler, scale, gauge, graph, and/or other graphic 706 that processor 202 animates to convey to the user 112a dimension of wear of the wear part. The illustrated template element 705 of FIG. 11A includes lengths from a new wear component with incremental measurements to dimensions of safety concerns (e.g. 21-12 inches). The template 705 may be animated, augmented reality, or static on the GUI 701. The template 705 may indicate by color the dimensions that indicate wear has reached a threshold or minimum dimension (e.g. shown the last length in FIGS. 11A-11B). At such lengths, the wear of the point 703, 703A may damage the underlying earth working machine 110 or adapter, reduce performance (e.g., penetrability) and/or the like. In one example, if processor 200 determines that the amount of wear is above a threshold (e.g., 15 inches), then the processor 200 may send an alert indication to the alert notification system 106, which will in turn send an alert email to client-side computing system 108 with the minimum dimension measurement. The template 705 may also include a color that indicates the dimension is just above the threshold (e.g. lengths 15-17 in FIG. 11A). The yellow color may indicate to the software to recommend to the client to rotate the wear components 103.

In one implementation, the user 112 will align the template over the wear part image 703 (e.g., with a finger moving the template lines on the screen). In another implementation the processor 202 will align the template 705 over the wear part image 703. Where the template 705 gets positioned over the wear part image 703 is determined by reference points 707. The processor 202 or user 112 may identify, in the digital representation 703, one or more features 707 of the wear part that serve as a basis to measure from the wear edge and determine the current dimension of the wear part 103. Such reference points 707 may include e.g., a rear edge of the wear component, side surfaces of the wear component, a portion or edge of the lock, a front and/or rear edge of lock cavity and/or a front edge of a lifting eye or what remains of the lifting eye.

In FIG. 11A, reference points 707 are set by aligning one line (in this example the horizontal line 709) with the front edge of rear lock receiving tabs of the digital representation of the point 703, and aligning the other lines (in this example the vertical lines 710) at the point where the sides of the digital representation of the point 703 intersect the horizontal line, such that a known dimension, e.g. a reference width 711 properly aligns the template 705. Alternatively, the horizontal line 709 could be aligned with the rear edge of the tabs or along the tabs. The template 702 may include at least two reference points 707 to overlay onto the wear part image 703. Other reference distances could be used in lieu of or in addition to reference width 711. For example, in FIG. 11A, the distance from the horizontal line 708 toa second horizontal line 708 at a front edge of a lifting eye 720 or what remains of the lifting eye 720 could form an alternative or redundant reference distance. While there may be some variation due to the imaging device 212 not being precisely parallel to the top side of the wear part, such variations are small enough to be discounted for the purposes of the inspection. Setting the reference points 707 or lines 708, 709, 710 for the template enables the software to properly scale the template for the wear component being monitored.

In FIG. 11B, where there are no lock receiving tabs at the rear end, the horizontal line 708 can be placed (by the operator or by software) along the central rear edge of the wear component 703A. Alternatively, the horizontal line 708 could be aligned with the outer rear edges of the wear component. The vertical lines 710 are placed where the sides of the wear component intersection of the horizontal line 708. This enables the software to align the template 705 with a known dimension, e.g. a reference width 711 for the wear component. Other reference distances in lieu of or in addition to the reference width 711 could be used as a known dimension. For example, the front edge 714 of the lock opening could be used to define a reference length 712, i.e., from the horizontal line (in this example) to the front edge of the lock. One or more of the known dimensions could then be used for the software to set the scale for the template.

Once the template 705 is properly aligned and scaled, a dimension 720 of the wear component 103 can be determined by the user 112, by software, and/or by a user at a remote location. For example, in FIGS. 11A-11B, the measured dimension 720 is length is 21 inches. The measured length 720 can then be compared to the length of the wear component when new (or alternatively a previous measurement) to determine wear. From this determination a report can be transmitted to the client-side computing system 108 as described above.

In another implementation the template 705 may be overlaid on the imaging device software, so it appears when the user 112 captures the image. The template 705 may be resized or scaled to fit the digital representation capture interface 400.

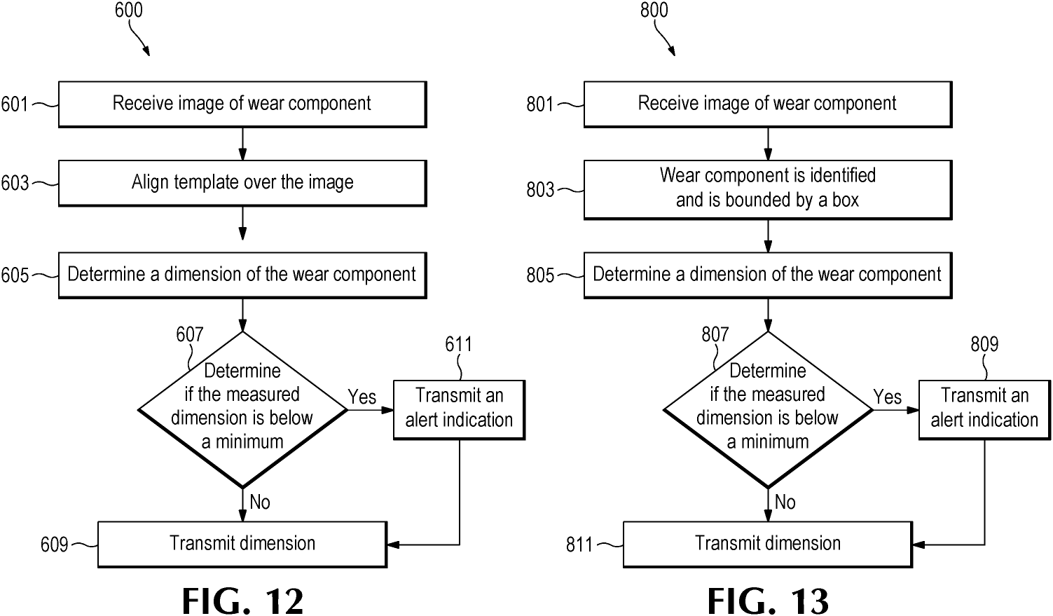

With reference to FIG. 12, a flowchart illustrating an exemplary process or method 600 for processing an image for calculating wear and/or an alert notification. The process 600 may be implemented in program instructions in the context of any of the software applications, modules, components, or other such programming elements deployed in a computing system 201. The program instructions direct the underlying physical or virtual computing system or systems to operate as follows, referring parenthetically to the steps.

To begin, in one example process, the image processing system 104 receives an image 703 of a wear component as data (Step 601). This image 703 taken from an imaging device may come from the mobile application 215 on the mobile device or an application run on a tool, vehicle, robot, or drone. The image 703 received as data, wired or wirelessly, may include the digital representation of the wear component 103. The image is preferably captured from above or angled at the top of the wear component but could be at other positions. Next, a template 705 is aligned over the image 703 of the wear component 103 (FIGS. 11A-11B) (Step 603). A dimension 720 of the wear component 103 is determined (Step 605). Determine if the dimension of the wear component is at or below a minimum dimension for usage without damaging other components (Step 607). If the dimension 720 is at or below a minimum dimension, then an alert indication is transmitted (Step 609). An alert indication may also be generated for a dimension 720 that is at a rotation dimension, e.g. prior to end of life. If not, then the dimension is not at the threshold, then transmit the dimension 720 of the wear component 103 to the client-side computing system (Step 611).

A report may be transmitted to the client-side computing system 108. The report may contain, for example, the identity of user 112, machine 110, the wear part 103, the location on the earth working machine 110 (e.g. position 5), the amount of wear, degree of wear (e.g. 65%), end of life prediction, and/or other information that apprises the client of the situation so that the client can take further action, if warranted.

In another example, with reference to FIG. 13, an exemplary process or method 800 for processing an image for calculating wear and/or an alert notification is shown. The process 800 may be implemented in program instructions in the context of any of the software applications, modules, components, or other such programming elements deployed in a computing system 201. The program instructions direct the underlying physical or virtual computing system or systems to operate as follows, referring parenthetically to the steps.

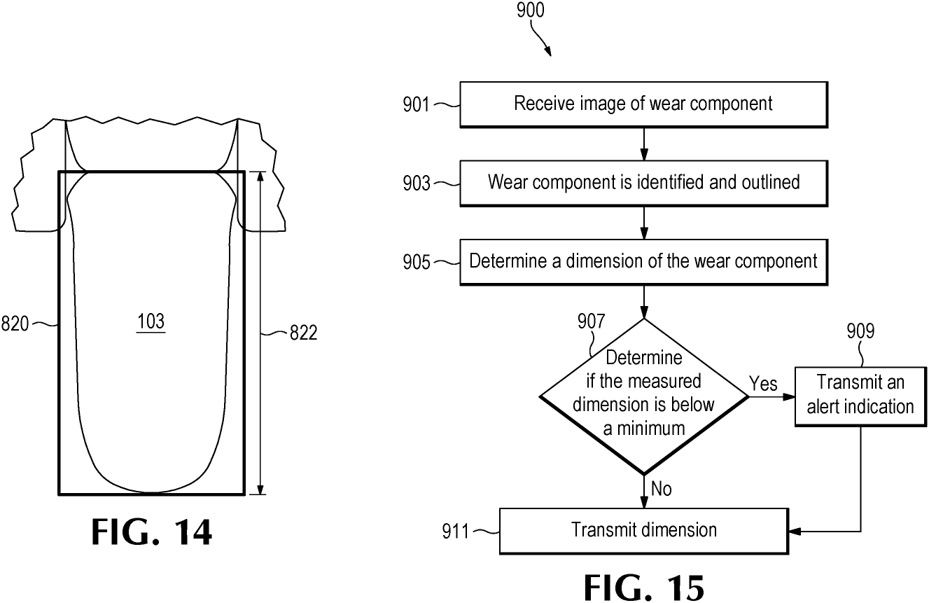

To begin, in one example process, the image processing system 104 receives an image 819 of a wear component 103 as data (Step 801). This image taken from an imaging device may come from the mobile application 215 on the mobile device or an application run on a tool, vehicle, robot, or drone. The image received as data, wired or wirelessly, may include the digital representation of the wear component 103. The image is preferably captured from above or angled at the top of the wear component but could be at other orientations. Next, the wear component 103 is identified as being the one to be measured and the wear component 103 is bounded by a rectangular box 820 (FIG. 14) (Step 803). The box 820 could be about the entire wear component 103 or could bound a specific reference point, e.g. a lock and the end of the wear component 103. The bounding of the wear component 103 could be a learned step from machine learning, e.g. through training a neural network. A dimension 822 of the wear component 103 is determined by using the aspect ratio (e.g. width:length or width/length in pixels) of the box and a known dimension (e.g. in pixels) (Step 805). The known dimension could be done via the first process 600 (e.g. learned) or could be measured by hand, so that a given aspect ratios can be associated with a specific dimension, such as a length of the wear component 103. Once a comparable length is known, then a dimension can be determined. The more known data points, the easier it is to determine the dimension of the wear component 103. Next, determine if the dimension 822 of the wear component 103 is at or below a minimum dimension for usage without damaging other components (Step 807). If the dimension is at or below a minimum dimension, then an alert indication is transmitted (Step 809). An alert indication may also be generated for a dimension that is at a rotation dimension, e.g. prior to end of life. If not, then the dimension is not at the threshold, then transmit the dimension of the wear component to the client-side computing system (Step 811).

In yet another example, with reference to FIG. 15, an exemplary process or method 900 for processing an image for calculating wear and/or an alert notification is shown. The process 900 may be implemented in program instructions in the context of any of the software applications, modules, components, or other such programming elements deployed in a computing system 201. The program instructions direct the underlying physical or virtual computing system or systems to operate as follows, referring parenthetically to the steps.

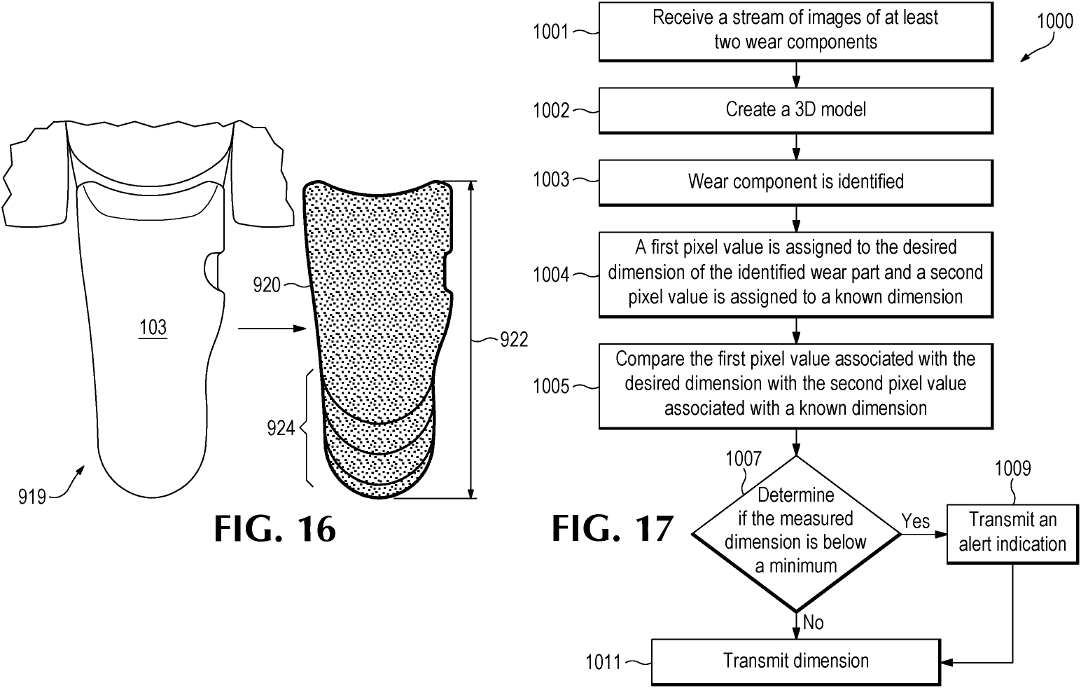

To begin, in one example process, the image processing system 104 receives an image 919 of a wear component 103 as data (Step 901). This image taken from an imaging device may come from the mobile application 215 on the mobile device or an application run on a tool, vehicle, robot, drone, or the like. The image 919 is preferably captured from above or angled at the top of the wear component but other orientations are possible. The image 919 received as data wired or wirelessly may include the digital representation of the wear component 103. Next, the wear component 103 is identified as being the one to be measured and the wear component 103 is outlined by a filling outline 920 (FIG. 16) (Step 903). The outline 920 could fill in the entire wear component 103 as illustrated or could be just the outline of the wear component 103. The outlining of the wear part could be a learned step from machine learning, e.g. through training a neural network. A dimension 922 of the wear component 103 is determined by normalizing the outlined image and comparing with known wear profiles 924, e.g. outlines of teeth worn to a particular state (Step 905). The known wear profiles 924 could have been measured by hand, so that certain outlines are associated with known dimensions, such as lengths of points. Next, determine if the dimension 922 of the wear component is at or below a minimum dimension for usage without damaging other components (Step 907). If the dimension 922 is at or below a minimum dimension, then an alert indication is transmitted (Step 909). An alert indication may also be generated for a dimension that is at a rotation dimension, e.g. prior to end of life. If not, then the dimension is not at the threshold, then transmit the dimension of the wear component to the client-side computing system (Step 911).

In a further example, with reference to FIG. 17, an exemplary process or method 1000 for processing an image for calculating wear and/or an alert notification is shown. The process 1000 may be implemented in program instructions in the context of any of the software applications, modules, components, or other such programming elements deployed in a computing system 201. The program instructions direct the underlying physical or virtual computing system or systems to operate as follows, referring parenthetically to the steps.

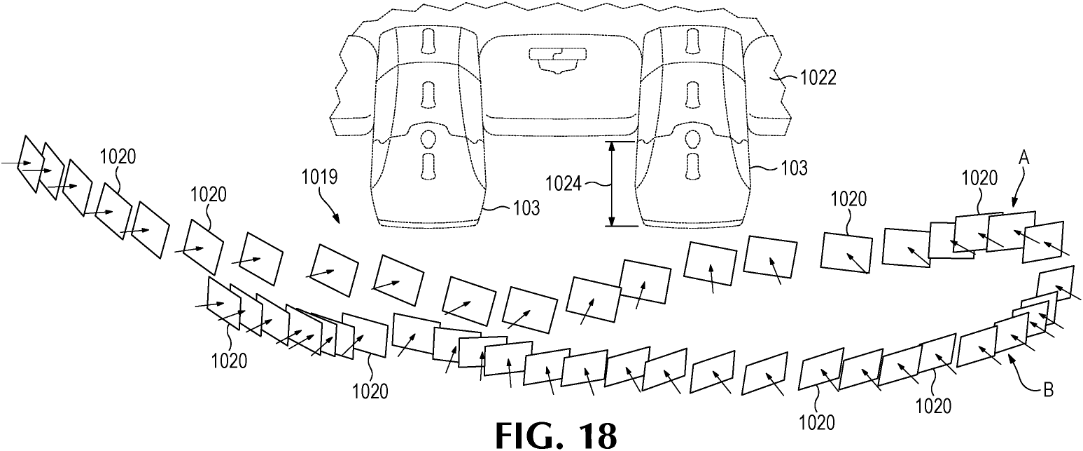

To begin, in one example process, the image processing system 104 receives a stream 1019 of images 1020 of at least two wear components, e.g. video as data (Step 1001). The video taken from an imaging device may come from the mobile application 215 on the mobile device or an application run on a tool, vehicle, robot, drone, or the like. The images 1020 received as data or a stream of data, wired or wirelessly, may include more than two wear components 103. The video is preferrable taken from, e.g., above, the front, or angled from the top of the wear component. The video may include multiple paths A, B, within a single video or more than one video, such that a top pass A is accomplished, and a front pass B is accomplished (FIG. 18). Other configurations may be possible, e.g. a single pass, a single pass above the lip, a triple pass where one is above the lip, another pass is at an angle, and the third pass being at the front of the lip, among other examples of the like. Next, a 3D model 1022 is created (FIG. 18) (Step 1002). A wear component 103 is identified as being the one to be measured (Step 1003). The identification of the wear component may be accomplished through many different means, such as 3D image segmentation, boundary boxing, or outlining as explained above. The identification of the wear component 103 could be a learned step from machine learning, e.g. through training a neural network. Next, a first pixel value is assigned to the desired dimension 1024 of the identified wear part and a second pixel value 1026 is assigned to a known dimension (Step 1004). The desired dimension 1024 of the wear component 103 is determined by comparing the first pixel value associated with the desired dimension with the second pixel value associated with a known dimension (e.g. 600 pixels is equivalent to 300 cm) and converting the pixel value to a unit of dimension (e.g. inch, cm, and the like) (Step 1005). Known dimensions 926 may be used to determine the dimension of the specific wear component in the 3D model 1022. For example, a known dimension 1026 may be a shroud length, shroud width, wear cap width, wear cap length, a distance between two wear parts (e.g. points, shrouds), a length of an adapter leg to the end of the lip of the bucket, length of an intermediate adapter, and the like (FIG. 20). With the known dimension 1026, the pixel dimension can be scaled and a dimension of a particular region of interest 1024, e.g. a length of a point 103, can be determined. Next, determine if the dimension 1024 of the wear component 103 is at or below a minimum dimension for usage without damaging other components (Step 1007). If the dimension 1024 is at or below a minimum dimension, then an alert indication is transmitted (Step 1009). An alert indication may also be generated for a dimension that is at a rotation dimension, e.g. prior to end of life. If not, then the dimension 1024 is not at the threshold, then transmit the dimension of the wear component to the client-side computing system (Step 1011).

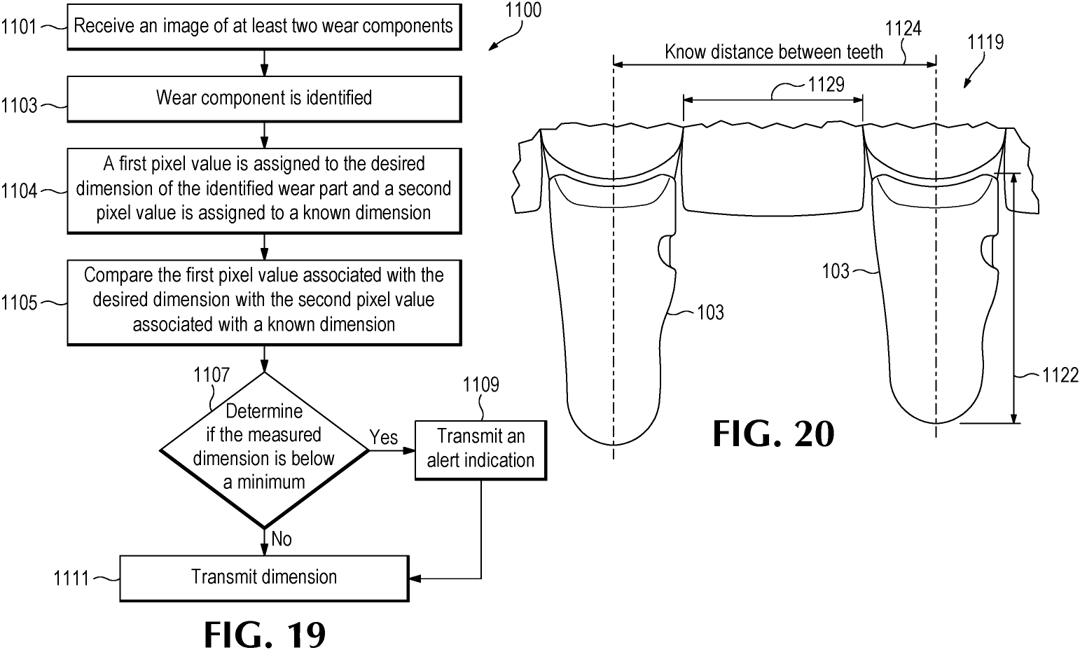

In another example, with reference to FIG. 19, an exemplary process or method 1100 for processing an image for calculating wear and/or an alert notification is shown. The process 1100 may be implemented in program instructions in the context of any of the software applications, modules, components, or other such programming elements deployed in a computing system 201. The program instructions direct the underlying physical or virtual computing system or systems to operate as follows, referring parenthetically to the steps.

To begin, in one example process, the image processing system 104 receives an image 1119 of at least two wear components as data (Step 1101). This image taken from an imaging device may come from the mobile application 215 on the mobile device or an application run on a tool, vehicle, robot, or drone. The image 1119 is received as data, wireless or wired. Next, the wear component 103 is identified as being the one to be measured (FIG. 20) (Step 1103). The identification of the wear component 103 may be accomplished through many different means, such as 2D or 3D image segmentation, boundary boxing, or outlining as explained above. The identification could be a learned step from machine learning, e.g. through training a neural network. Next, a first pixel value is assigned to the desired dimension 1122 of the identified wear part 103 and a second pixel value 1026 is assigned to a known dimension 1124 (Step 1104). The desired dimension 1122 of the wear component 103 is determined by comparing the first pixel value associated with the desired dimension with the second pixel value associated with a known dimension 1124 (e.g. 600 pixels is equivalent to 300 cm) and converting the first pixel value to a unit of dimension (e.g. inch, cm, and the like) (Step 1105). Known dimensions may be used to determine the dimension of the specific wear component in the 3D model. For example, a known dimension 1124 may be a shroud length, shroud width, wear cap width, wear cap length, a distance between two wearable points, a distance between two shrouds, a length of an adapter leg to the end of the lip of the bucket, and the like (FIG. 20). With the known dimension 1124, the pixel dimension of the desired dimension 1122 can be scaled and a dimension of a particular region of interest, e.g. a point, can be determined. Next, determine if the dimension 1122 of the wear component is at or below a minimum dimension for usage without damaging other components (Step 1107). If the dimension 1122 is at or below a minimum dimension, then an alert indication is transmitted (Step 1109). An alert indication may also be generated for a dimension that is at a rotation dimension, e.g. prior to end of life. If not, then the dimension 1122 is not at the threshold, then transmit the dimension of the wear component to the client-side computing system (Step 1111).

Any of the image processing processes may further include determining the amount of wear and/or the amount of wear from last known image. From this data, a prediction for end of life can be calculated. The prediction may take into account the work bench or the material being worked on that specific day. The location and earthen material type and size determined from the work bench image may affect the end of life prediction.

As will be appreciated by one skilled in the art, examples of the present invention may be embodied as a system, method, or computer program product. Accordingly, examples of the present invention may take the form of an entirely hardware example, an entirely software example (including firmware, resident software, micro-code, etc.) or an example combining software and hardware implementations that may all generally be referred to herein as a “circuit,” “module” or “system.” Furthermore, implementations of the present invention may take the form of a computer program product embodied in one or more computer readable medium(s) having computer readable program code embodied thereon.

The foregoing descriptions of the disclosure have been presented for purposes of illustration and description. They are not exhaustive and do not limit the disclosure to the precise form disclosed. Modifications and variations are possible in light of the above teachings or may be acquired from practicing of the disclosure. For example, the described implementation includes software, but the present disclosure may be implemented as a combination of hardware and software or in hardware alone. Additionally, although aspects of the present disclosure are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM.

One or more aspects of the disclosure may be embodied in computer-usable data or computer-executable instructions, such as in one or more modules, executed by one or more computers or other devices to perform the operations described herein. Generally, modules include routines, programs, objects, components, data structures, and the like that perform particular operations or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the modules may be combined or distributed as desired in various examples. In addition, the functionality may be embodied in whole or in part in firmware or hardware equivalents, such as integrated circuits, application-specific integrated circuits (ASICs), field programmable gate arrays (FPGA), and the like. Particular data structures may be used to implement one or more aspects of the disclosure more effectively, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware example, an entirely software example, an entirely firmware example, or an example combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner or may be located in a single computing device (e.g., a server, a client computer, mobile device, and the like). For example, in alternative examples, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative examples thereof. Numerous other examples, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1-46. (canceled)

47. A method for determining a dimension of a wear part using a digital representation comprising:
capturing at least one digital representation of a first wear part of an earth working machine;
receiving, the digital representation of the first wear part;
identifying the first wear part in the image;
bounding the identified first wear part within an outline of the wear part; and
determining a dimension of the identified first wear part by relating the bounded first wear part with on a wear profile associated with a second wear part having a known dimension.

48. The method of claim 47, wherein the identification of the first wear part is performed by a convolution neural network.

49. The method of claim 47, wherein the digital representation is a top view of the first wear part.

50. The method of claim 47, where the dimension of the first wear part is a length of the first wear part.

51. The method of claim 50, wherein the length of the first wear part is used to determine the amount of wear since a previous determination.

52. The method of claim 51, wherein the amount of wear since a previous determination and the time between determinations is used to predict an end of life for the first wear part.

53. The method of claim 47, further comprising capturing an image of a work bench surrounding the first wear part.

54. The method of claim 47, further comprising determining if the determined dimension is below a minimum and if so, then transmitting an alert indication.

55-66. (canceled)

67. A method for determining a dimension of a wear part using a digital representation comprising:
capturing a plurality of digital representations of at least two wear parts of an earth working machine;
receiving, the stream of the plurality of digital representations of the at least two wear parts;
modeling the at least two wear parts as a 3-dimensional (3D) object using the digital representations;
identifying at least two wear parts;
assigning a first pixel value associated with a desired dimension on one of the at least two wear parts and a second pixel value for a known dimension; and
determining the desired dimension of the at least one wear part by relating the first pixel value with the second value.

68. The method of claim 67, wherein the identification of the at least two wear parts is performed by 3D image segmentation, boundary boxing, and/or outlining.

69. The method of claim 67, wherein the plurality of digital representations contains a continuous pass of at least one of above, at an angle from, and/or the front of the lip of a bucket.

70. The method of claim 67, wherein the modeling of the at least two wear parts is done by photogrammetry.

71. The method of claim 67, where the dimension of the at least one wear part is a length of the at least one wear part.

72. The method of claim 71, wherein the length of the at least one wear part is used to determine the amount of wear since a previous determination.

73. The method of claim 72, wherein the amount of wear since a previous determination and the time between determinations is used to predict an end of life for the at least one wear part.

74. The method of claim 67, further comprising capturing an image of a work bench surrounding the at least two wear parts.

75. The method of claim 67, further comprising determining if the determined dimension is below a minimum and if so, then transmitting an alert indication.

76. The method of claim 67, wherein the known dimension is one of a shroud length, shroud width, wear cap width, wear cap length, a distance between two points, a distance between two shrouds, or a length of an adapter leg to the end of the lip of the bucket.

77-90. (canceled)

91. A method for determining a dimension of a wear part using a digital representation comprising:
capturing a digital representation of at least two wear parts of an earth working machine;
receiving, the digital representation of the at least two wear parts;
identifying at least two wear parts;
assigning a first pixel value associated with a desired dimension on one of the at least two wear parts and a second pixel value for a known dimension; and
determining the desired dimension of the at least one wear part by relating the first pixel value with the second value.

92. The method of claim 91, wherein the identification of the wear part is performed by 2-dimensional image segmentation, boundary boxing, and/or outlining.

93. The method of claim 91, where the dimension of the at least one wear part is a length of the at least one wear part.

94. The method of claim 93, wherein the length of the wear part is used to determine the amount of wear since a previous determination.

95. The method of claim 94, wherein the amount of wear since a previous determination and the time between determinations is used to predict an end of life for the at least one wear part.

96. The method of claim 91, further comprising capturing an image of a work bench surrounding the at least one wear part.

97. The method of claim 91, further comprising determining if the determined dimension is below a minimum and if so, then transmitting an alert indication.

98. The method of claim 91, wherein the known dimension is one of a shroud length, shroud width, wear cap width, wear cap length, a distance between two points, a distance between two shrouds, or a length of an adapter leg to the end of the lip of the bucket.

99-110. (canceled)
